(19) United States
(12) Patent Application Publication
(10) Pub. No.: US 2015/0255795 A1
(43) Pub. Date: Sep. 10, 2015

(54) LITHIUM ION SECONDARY BATTERY

(71) Applicant: TDK CORPORATION, Tokyo (JP)

(72) Inventors: Atsushi Sano, Tokyo (JP); Keitaro Otsuki, Tokyo (JP)

(21) Appl. No.: 14/431,473

(22) PCT Filed: Sep. 27, 2013
(86) PCT No.: PCT/JP2013/076193

§ 371 Date: Mar. 26, 2015

(30) Foreign Application Priority Data
Sep. 28, 2012 (JP) 2012-216655

(51) Int. Cl. H01M 4/58; H01M 2/02; H01M 10/0525

(52) U.S. Cl. CPC H01M 4/5825; H01M 10/0525; H01M 2/0287; H01M 2004/028

(57) ABSTRACT

The present invention aims to obtain a lithium ion secondary battery having excellent high-rate discharge characteristics. A lithium ion secondary battery includes a positive electrode, a negative electrode, and an electrolyte solution and is characterized in that the positive electrode uses a compound expressed by an expression as a positive electrode active material, and the positive electrode has an electrode density of 1.8 to 2.9 g/cm³, the expression being Liₐ(M)_{b}(PO₄)_{c}X_{d} (where M is VO or V, X is F, and 0.9≦a≦3.3, 0.9≦b≦2.2, 0.9≦c≦3.3, 0≦d≦1.1).

The present invention relates to a lithium ion secondary battery.

### BACKGROUND

Conventionally, as the positive electrode material (positive electrode active material) of lithium ion secondary batteries, a stacked compound, such as LiCoO₂ or LiNi_{1/3}Mn_{1/3}Co_{1/3}O₂, and a spinel compound, such as LiMn₂O₄, have been used. In recent years, attention is being focused on olivine-type structure compounds, such as represented by LiFePO₄. Positive electrode material having the olivine structure is known to have high thermal stability at high temperatures and a high degree of safety. However, a lithium ion secondary battery using LiFePO₄ has a low charging/discharging voltage of around 3.5 V, resulting in the disadvantage of low energy density. Thus, as a phosphoric acid-based positive electrode material capable of achieving high charging/discharging voltage, LiCoPO₄, LiNiPO₄ and the like have been proposed. However, even in the lithium ion secondary battery using such positive electrode material, sufficient capacity cannot be obtained at present. As compounds that can achieve charging/discharging voltage on the order of 4 V among phosphoric acid-based positive electrode materials, vanadium phosphate having a Liₐ(M)_{b}(PO₄)_{c}X_{d} (Patent Document 2) structure is known, such as LiVOPO₄ (Patent Document 1) or Li₃V₂(PO₄)₃. However, the vanadium phosphate has the problem of inferior high-rate discharge characteristics compared with the other positive electrode material, such as LiFePO₄.

### PATENT DOCUMENTS

Patent Document 1: JP-A-2004-303527

Patent Document 2: JP-A-2008-123823

### SUMMARY

The present invention was made in view of the problems of the conventional art, and an object of the invention is to provide a lithium ion secondary battery capable of improving high-rate discharge characteristics of the lithium ion secondary battery.

In order to achieve the object, a lithium ion secondary battery according to the present invention includes a positive electrode, a negative electrode, and an electrolyte solution, and is characterized in that the positive electrode uses a compound expressed by an expression (1) as a positive electrode active material; and the positive electrode has an electrode density of 1.8 to 2.9 g/cm³, the expression (1) being Liₐ(M)_{b}(PO₄)_{c}X_{d} (where M is VO or V, X is F, and 0.9≦a≦3.3, 0.9≦b≦2.2, 0.9≦c≦3.3, 0≦d≦1.1).

By the above means, a lithium ion secondary battery having excellent high-rate discharge characteristics can be obtained.

Preferably, in the lithium ion secondary battery according to the present invention, the electrolyte solution may include a lithium salt, and the lithium salt may have a salt concentration of 1.1 to 1.7 mol/L.

Preferably, in the lithium ion secondary battery according to the present invention, the positive electrode may have a BET specific surface area as an electrode of 5 to 20 m²/g.

Preferably, in the lithium ion secondary battery according to the present invention, the positive electrode may have a pore volume of 0.01 to 0.1 cm³/g.

Preferably, in the lithium ion secondary battery according to the present invention, the positive electrode may have a positive electrode active material loaded amount of 5 to 20 mg/cm².

Preferably, in the lithium ion secondary battery according to the present invention, the positive electrode may be LiVOPO₄ or L₃V₂(PO₄)₃.

According to the present invention, a lithium ion secondary battery having excellent high-rate discharge characteristics can be provided.

### BRIEF DESCRIPTION OF THE DRAWINGS

FIG. 1 is a schematic cross sectional view of a lithium ion secondary battery.

### DETAILED DESCRIPTION OF EMBODIMENTS

In the following, a preferred embodiment of the present invention will be described with reference to the drawings. In the drawings, similar or corresponding portions will be designated with similar signs, and redundant description will be omitted. Positional relationships, such as upper/lower and right/left, are based on the positional relationships illustrated in the drawings unless otherwise noted.

### <Positive Electrode>

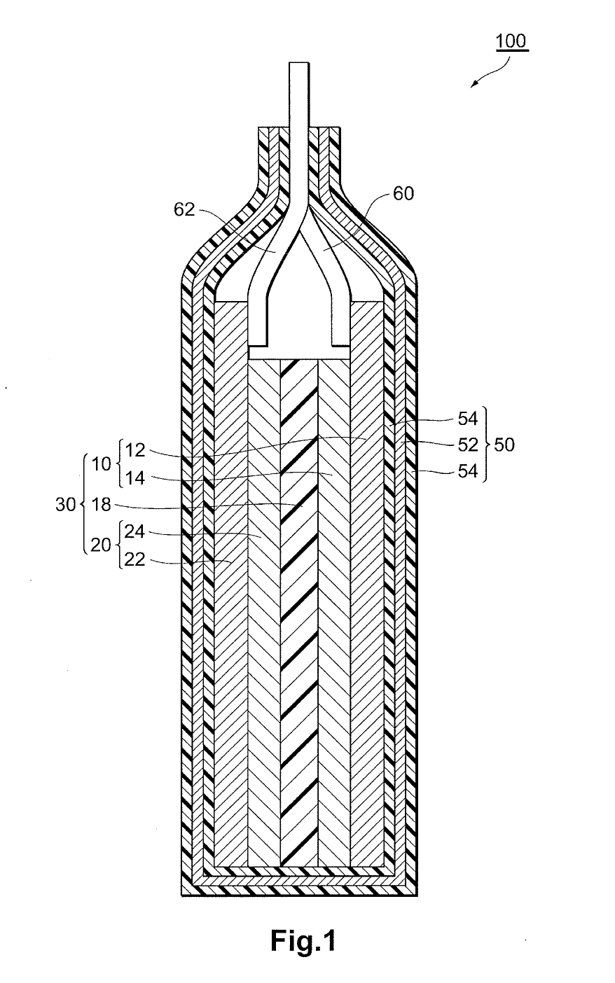

In the following, an electrode according to the present embodiment will be described (see a positive electrode 10 in FIG. 1).

The electrode 10 uses Liₐ(M)_{b}(PO₄)_{c}X_{d} (where M is VO or V, X is F, and 0.9≦a≦3.3, 0.9≦b≦2.2, 0.9≦c≦3.3, 0≦d≦1.1) as a positive electrode active material, and has an electrode density of 1.8 to 2.9 g/cm³.

The “electrode density” herein is determined by dividing the weight per area of an electrode coating film by the thickness of the electrode coating film.

Specifically, the electrode density is determined according to an expression: electrode density [g/cm³]=(weight of electrode coating film per unit area) [mg/cm²]/(electrode coating film thickness) [μm]×10. The “electrode coating film” refers to a layer including the active material applied onto a current collector, a conductive auxiliary agent, and a binder and the like.

The lithium ion secondary battery using the positive electrode 10 provides excellent high-rate discharge characteristics presumably for the following reason. It is believed that when the electrode density is 1.8 to 2.9 g/cm³, improved contact is obtained between the positive electrode active material and the conductive auxiliary agent, whereby increased electronic conductivity is achieved while resistance is decreased, increasing the high-rate discharge capacity. The electrode density may be adjusted using a roll press, a thermal roll press, or a flat plate press. The density can be adjusted by adjusting temperature, pressure, or roll-to-roll gap.

Preferably, the positive electrode 10 has a BET specific surface area as an electrode of 5 to 20 m²/g. It is believed that when the BET specific surface area as an electrode of the positive electrode is 5 to 20 m²/g, enhanced affinity with an electrolyte solution can be obtained, whereby sufficient ion conductivity is believed to be ensured.

The BET specific surface area can be determined, in a normally used method, by causing nitrogen adsorption and desorption while changing pressure, and using a BET adsorption isotherm equation. The BET specific surface area of the electrode can be measured by cutting a part of the electrode and inserting the electrode into a sample tube.

Preferably, the positive electrode 10 has a pore volume of 0.01 to 0.1 cm³/g. In this way, better high-rate discharge characteristics can be obtained. This is presumably due to the following phenomenon. The pore volume of the positive electrode 10 is impregnated with electrolyte solution to ensure ion conductivity. It is believed that by ensuring necessary and sufficient pores, excellent high-rate discharge characteristics can be obtained.

The pore volume can be determined by nitrogen adsorption and desorption. It is believed that the pore volume obtained by this method is the pore volume of pores of approximately 1000 Å or less.

More preferably, the positive electrode 10 has an electrode active material loaded amount of 5 to 20 mg/cm². In this way, better high-rate discharge characteristics can be obtained.

### <Positive Electrode Manufacturing Method>

### Slurry Fabrication Step

### (Raw Material Mixture)

In a slurry fabrication step, first, a raw material mixture is prepared. The raw material mixture includes Liₐ(M)_{b}(PO₄)_{c}X_{d} as a positive electrode active material, a conductive auxiliary agent, and a binder. Preferably, the positive electrode active material has a BET specific surface area in a range of 1.0 to 20.0. When in this range, the material has high discharge capacity and provides excellent high-rate discharge characteristics. Preferably, the positive electrode active material has a mixture ratio of 80 to 98 wt %. When in this range, a lithium ion secondary battery having excellent high-rate discharge characteristics can be obtained.

Examples of the conductive auxiliary agent in the positive electrode 10 include carbons such as carbon blacks, graphites, carbon nanotube (CNT), and vapor-grown carbon fiber (VGCF). Examples of carbon blacks include acetylene black, oil furnace, and Ketjen black. Among others, it is preferable to use Ketjen black in terms of excellent conductivity. When Ketjen black and the positive electrode active material are mixed, a small amount of water and argon may be added and a bead mill process may be performed. Ketjen black, because of its large specific surface area and bulkiness, may interfere with the attempt to increase electrode density. By performing the bead mill process, adhesion between Ketjen black and the positive electrode active material can be increased, whereby electrode density can be increased. More preferably, one or more types of carbon including carbon blacks, graphites, carbon nanotube (CNT), and vapor-grown carbon fiber (VGCF) may be included. The specific surface area of the electrode can be adjusted depending on the type and mixture ratio of the conductive auxiliary agent. Preferably, the mixture ratio of the conductive auxiliary agent is 1 to 10 wt %. When in this range, a lithium ion secondary battery having excellent high-rate discharge characteristics can be obtained.

Examples of the binder for the positive electrode 10 include polyvinylidene fluoride (PVDF), fluorine rubbers based on vinylidene fluoride/hexafluoropropylene (VDF/HFP-based fluorine rubber), vinylidene fluoride/hexafluoropropylene/tetrafluoroethylene-based fluorine rubber (VDF/HFP/TFE-based fluorine rubber), aromatic polyamides, cellulose, styrene/butadiene rubber, isoprene rubber, butadiene rubber, and ethylene/propylene rubber. There may also be used thermoplastic elastomeric polymers, such as styrene/butadiene/styrene block copolymer and a hydrogen-added product thereof, styrene/ethylene/butadiene/styrene copolymer, styrene/isoprene/styrene block copolymer and a hydrogen-added product thereof. There may be further used syndiotactic 1,2-polybutadiene, ethylene/vinyl acetate copolymers, propylene/α-olefin copolymers (having a carbon number of 2 to 12) or the like. Preferably, from the viewpoint of increasing electrode density, the polymer used as the binder has a specific weight of greater than 1.2 g/cm³. Also preferably, from the viewpoint of increasing electrode density and enhancing bonding strength, the weight-average molecular weight is 700,000 or more. Preferably, the binder has a mixture ratio of 1 to 10 wt %. When in this range, a lithium ion secondary battery having excellent high-rate discharge characteristics can be obtained.

A slurry is prepared by adding to a solvent the above-described positive electrode active material and binder, and a required amount of conductive auxiliary agent. As the solvent, N-methyl-2-pyrrolidone and N,N-dimethylformamide for example can be used. The amount of the mixed solvent can be adjusted to carry out a thick mixing step referred to as kneading. By adjusting the solid content concentration and kneading time during kneading, the pore volume can be adjusted. This is believed due to the difference in how the active material, the conductive auxiliary agent, and the binder are compounded depending on the solid content concentration and kneading time during kneading.

### Coating and Drying Step

The slurry of which the viscosity has been adjusted after the kneading can be applied onto the positive electrode current collector 12 by a method selected as needed, such as from methods using a doctor blade, a slot die, a nozzle, or a gravure roll. By adjusting the coating amount or line speed, the positive electrode loaded amount can be adjusted to 5 to 20 mg/cm². The coating is followed by drying. While the drying method is not particularly limited, the pore volume of the electrode can be adjusted by the drying speed.

### Pressing Step

The coated and dried electrode is then pressed using a roll press. By heating the rolls and thereby softening the binder, a higher electrode density can be obtained. Preferably, the roll temperature is in a range of 100° C. to 200° C. By adjusting the roll press pressure, the roll-to-roll gap, and the roll temperature, or by adjusting the surface roughness of the roll surface, the specific surface area of the electrode can be adjusted.

When the resultant positive electrode 10 is used as the positive electrode of a lithium ion secondary battery, high high-rate discharge characteristics can be obtained.

### (Electrolyte Solution Manufacturing Method)

In the following, an electrolyte solution manufacturing method according to an embodiment of the present invention will be described.

As the electrolyte solution (an electrolyte aqueous solution or an electrolyte solution using organic solvent), lithium salt dissolved in a solvent is used. As the lithium salt, there can be used, for example, salts such as LiPF₆, LiClO₄, LiBF₄, LiAsF₆, LiCF₃SO₃, LiCF₃, CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, and LiBOB. Such salts may be used either individually or in combination of two or more kinds.

Preferably, the lithium salt in the electrolyte solution has a salt concentration of 1.1 to 1.7 mol/L. When the salt concentration is in this range, it is believed that the lithium salt can be uniformly distributed in the pores of the positive electrode 10, providing excellent high-rate performance. If the salt concentration of the lithium salt is lower than 1.1 mol/L, the overvoltage necessary for lithium ion migration is increased, whereby, it is believed, in the case of constant current, polarization appears large and the high-rate discharge characteristics deteriorate. If the lithium salt concentration is greater than 1.7 mol/L, the electrolyte viscosity is increased, whereby, it is believed, the lithium salt does not permeate the pores of the positive electrode 10 sufficiently.

As the organic solvent, preferable examples include propylene carbonate, ethylene carbonate, diethyl carbonate, dimethyl carbonate, and methylethyl carbonate. These may be used either individually or in combination of two or more kinds mixed in an arbitrary ratio.

The active material Liₐ(M)_{b}(PO₄)_{c}X_{d} (where M is VO or V, X is F, and 0.9≦a≦3.3, 0.9≦b≦2.2, 0.9≦c≦3.3, 0≦d≦1.1) according to the present embodiment can be expressed by structural formulae such as LiVOPO₄, Li₃V₂(PO₄)₃, or LiVPO4F. From the viewpoint of excellent high-rate discharge characteristics, LiVOPO₄ and/or Li₃V₂(PO₄)₃ is particularly preferable.

It is known that vanadium phosphate (LiVOPO₄ or Li₃V₂(PO₄)₃) can be synthesized by solid-phase synthesis, hydrothermal synthesis, carbo-thermal reduction process or the like. Among others, vanadium phosphate fabricated by hydrothermal synthesis process has a small particle diameter and tends to provide excellent rate performance Thus, vanadium phosphate fabricated by hydrothermal synthesis process is preferable as the positive electrode active material.

(Electrode, Lithium Ion Secondary Battery, and their Manufacturing Method)

As illustrated in FIG. 1, a lithium ion secondary battery 100 according to the present embodiment is provided with: a power generating element 30 including a plate-like negative electrode 20 and a plate-like positive electrode 10 which are disposed opposite each other, and a plate-like separator 18 disposed adjacently between the negative electrode 20 and the positive electrode 10; an electrolyte solution including lithium ions; a casing 50 housing the above in a hermetically sealed state; a negative electrode lead 62 of which one end is electrically connected to the negative electrode 20, with the other end thereof protruding outside the casing; and a positive electrode lead 60 of which one end is electrically connected to the positive electrode 10, with the other end thereof protruding outside the casing.

The negative electrode 20 includes a negative electrode current collector 22, and a negative electrode active material layer 24 stacked on the negative electrode current collector 22. The positive electrode 10 includes a positive electrode current collector 12, and a positive electrode active material layer 14 stacked on the positive electrode current collector 12. The separator 18 is positioned between the negative electrode active material layer 24 and the positive electrode active material layer 14.

Examples of the negative electrode active material included in the negative electrode active material layer 24 include: carbon material such as natural graphite, synthetic graphite, hard carbon, soft carbon, low temperature heat-treated carbon and the like; metals or alloys that can be combined with lithium, such as Al, Sn, and Si; amorphous compounds principally of an oxide, such as SiOₓ(1<x≦2) and SnOₓ(1<x≦2); lithium titanate (Li₄Ti₅O₁₂); and TiO₂. The negative electrode active material may be bound by a binder. The negative electrode active material layer 24 is formed in a step of coating the negative electrode current collector 22 with a paint including the negative electrode active material and the like, as in the case of the positive electrode active material layer 14.

In the present embodiment, the electrolyte solution may be other than a liquid and may be a gel electrolyte obtained by adding a gelling agent. Instead of the electrolyte solution, a solid electrolyte (a solid polymer electrolyte or an electrolyte made of ion conductive inorganic material) may be included.

The separator 18 may also be formed of an electrically insulating porous structure. Examples include a single-layer body or a stacked body made of films of polyethylene, polypropylene, or polyolefin, an extended film of the mixture of the resins, or a fibrous nonwoven fabric made of at least one type of constituent material selected from the group consisting of cellulose, polyester, and polypropylene.

The casing 50 hermetically seals the stacked body 30 and the electrolyte solution inside. The casing 50 is not particularly limited as long as it can suppress leakage of electrolyte solution to the outside, or the entry of external moisture and the like into the lithium ion secondary battery 100, for example. For example, as illustrated in FIG. 4, the casing 50 can utilize a metal laminate film made of a metal foil 52 coated on both sides with polymer films 54. When the metal laminate film is used as the casing, which may also be referred to as an outer package, a lithium ion secondary battery having excellent high-rate discharge characteristics can be obtained. The reason for this is not clear; however, it is inferred that the excellent high-rate discharge characteristics are obtained because the metal laminate film conforms to the expansion and contraction of the electrode and does not block the movement of lithium ions as the electrode is expanded or contracted when the lithium ions are intercalated in the electrode. As the metal foil 52, an aluminum foil can be utilized. As the polymer film 54, a film of polypropylene or the like may be utilized. For example, as the material for the outer polymer film 54, a polymer having a high melting point, such as polyethylene terephthalate (PET) or polyamide, is preferable. As the material for the inner polymer film 54, polyethylene, polypropylene or the like is preferable.

The leads 60 and 62 are formed from a conductive material such as aluminum.

While a preferable embodiment of the active material manufacturing method according to the present invention has been described, the present invention is not limited to the embodiment.

### EXAMPLES

In the following, the present invention will be described in more concrete terms with reference to Examples and Comparative Examples. However, the present invention is not limited to the following examples.

### Example 1

### Fabrication of Evaluation Cell

A paste was obtained by heating V₂O₅, LiOH, and H₃PO₄ at molar ratio of approximately 1:2:2 in a hermetically sealed container at 160° C. for 8 hours. The paste was then fired in the air at 600° C. for 4 hours. It was learned that the resultant particles were β-type LiVOPO₄. LiVOPO₄, Ketjen black, and polyvinylidene fluoride (PVdF) (HSV900 manufactured by Arkema) were mixed at the weight ratio of 80:10:10. Specifically, LiVOPO₄, Ketjen black, and water were put into a polyethylene container which was filled with argon, and were mixed in a bead mill at 300 rpm. Thereafter, PVdF was added. N-methyl-2-pyrrolidone (NMP) as solvent was then added, preparing a slurry. Thick mixing was performed for 0.5 hour, and then NMP was additionally put in to adjust the viscosity to 3000 cPs. Using doctor blade process, an aluminum foil as the current collector was coated, followed by drying at 90° C. for 10 minutes. Thereafter, a roll press heated to 90° C. was used for pressing at linear pressure of 1.5 t cm⁻¹, fabricating the positive electrode.

Next, for the negative electrode, synthetic graphite (FSN manufactured by BTR) and an N-methyl pyrrolidone (NMP) 5 wt % solution of polyvinylidene fluoride (PVdF) were mixed at the ratio of synthetic graphite:polyvinylidene fluoride=93:7, fabricating a slurry paint. The paint was applied to a copper foil as the current collector, dried, and then pressed, fabricating the negative electrode.

The positive electrode and the negative electrode were stacked with a separator of a microporous polyethylene film held between the electrodes, obtaining a stacked body (element body). The stacked body was placed in an aluminum laminate pack.

For the electrolyte solution, ethylene carbonate (EC) and diethyl carbonate (DEC) were mixed at a volume ratio of 3:7, and LiPF₆ was dissolved as supporting salt to achieve 1.0 mol/L. The electrolyte solution was injected into the aluminum laminate pack containing the stacked body, and the pack was vacuum-sealed, fabricating an evaluation cell according to Example 1.

### Examples 2 to 5, 11, 12, 15, 21 to 26, and Comparative Examples 1 and 2

Evaluation cells according to Examples 2 to 5, 11, 12, 15, 21 to 26 and Comparative Examples 1 and 2 were fabricated by the same method as in Example 1 with the exception that the electrode density and the electrode BET specific surface area were modified by adjusting the pressing condition and that the pore volume was modified by adjusting the electrode drying condition.

### Examples 9, 10, 17 to 20

Evaluation cells according to Examples 9, 10, 17 to 20 were fabricated by the same method as in Example 1 with the exception that the positive electrode active material loaded amount was modified by coating condition modification, that the electrode density and the electrode BET specific surface area were modified by pressing condition adjustment, and that the pore volume was modified by adjusting the electrode drying condition.

### Examples 6 to 8, 27, and 28

Evaluation cells according to Examples 6 to 8, 27, and 28 were fabricated by the same method as in Example 4 or Example 9 with the exception that the lithium salt concentration was modified.

### Example 13

An evaluation cell according to Example 13 was fabricated by the same method as in Example 4 with the exception that Li₃V₂(PO₄)₃ was used as the positive electrode active material, and that the electrode BET specific surface area and the pore volume were modified.

### Example 14

An evaluation cell according to Example 14 was fabricated by the same method as in Example 4 with the exception that LiVPO₄F was used as the positive electrode active material, and that the electrode BET specific surface area and the pore volume were modified.

### Example 29

For the negative electrode, synthetic graphite (FSN manufactured by BTR), silicon powder (manufactured by Aldrich), and N-methyl pyrrolidone (NMP) 5 wt % solution of polyvinylidene fluoride (PVdF) were mixed at the ratio of synthetic graphite:silicon powder:polyvinylidene fluoride=84:9:7, fabricating a slurry paint. The paint was applied to a copper foil as the current collector, followed by drying and pressing, fabricating the negative electrode. An evaluation cell according to Example 29 was fabricated by the same method as in Example 4 with the exception that the negative electrode fabricated by the above method was used.

### Example 30

For the negative electrode, synthetic graphite (FSN manufactured by BTR), silicon powder (manufactured by Aldrich), and N-methyl pyrrolidone (NMP) 5 wt % solution of polyvinylidene fluoride (PVdF) were mixed at the ratio of synthetic graphite:silicon powder:polyvinylidene fluoride=75:18:7, fabricating a slurry paint. The paint was applied to a copper foil as the current collector, followed by drying and pressing, fabricating the negative electrode. An evaluation cell according to Example 30 was fabricated by the same method as in Example 4 with the exception that the negative electrode fabricated by the above method was used.

### Example 31

For the negative electrode, silicon oxide powder SiO and an N-methyl pyrrolidone (NMP) 20 wt % solution of polyamide-imide (PAI) were mixed at the ratio of SiO:PAI=85:15, fabricating a slurry paint. The paint was applied to a copper foil as the current collector, followed by drying and pressing, fabricating the negative electrode. An evaluation cell according to Example 31 was fabricated by the same method as in Example 4 with the exception that the negative electrode fabricated by the above method was used.

### Examples 32 to 35

Evaluation cells according to Examples 32 to 35 were fabricated by the same method as in Example 13 with the exception that the electrode density and the electrode BET specific surface area were modified by press condition adjustment, and that the pore volume was modified by adjusting the electrode drying condition.

### Rate Performance Evaluation

The rate performance (unit: %) of Example 1 was respectively determined. The rate performance is the discharge capacity rate at 1 C when the discharge capacity at 0.1 C is 100%. The results are shown in Table 1. The greater the rate performance, the better.

It is seen from the results of Examples 1 to 5, 22 to 26, and Comparative Examples 1 and 2 in Table 1 that excellent rate performance are obtained when the electrode density of the positive electrode is 1.8 to 2.9 g/cm³ and the BET specific surface area as an electrode of the positive electrode is 5 to 20 m²/g. From the results of Examples 6 to 8, 16, 27, 28, and Comparative Examples 3 and 4, it is seen that even better characteristics are exhibited when the salt concentration of the lithium salt is 1.1 to 1.7 mol/L. From the results of Examples 9, 10, 17 to 20, it is seen that excellent rate performance is exhibited when the electrode active material loaded amount is 4 to 21 mg/cm².

TABLE 1

| | | | | BET specific | pore | | |
|---|---|---|---|---|---|---|---|
| | | active material | electrode | surface area of | volume | lithium salt | rate |
| | positive | loaded amount | density | the electrode | (cm³/g × | concentration | performance |
| | electrode | (mg/cm²) | (g/cm³) | (m²/g) | 10⁻³) | (mol/L) | (2 C/0.1 C) |
| Example 1 | LiVOPO₄ | 12 | 2.05 | 15 | 1.6 | 1 | 67.1 |
| Example 2 | LiVOPO₄ | 12 | 2.1 | 12 | 2.5 | 1 | 68.3 |
| Example 3 | LiVOPO₄ | 12 | 2.2 | 10 | 3.6 | 1 | 70.2 |
| Example 4 | LiVOPO₄ | 12 | 2.3 | 8 | 4.8 | 1 | 72.1 |
| Example 5 | LiVOPO₄ | 12 | 2.5 | 6 | 5.6 | 1 | 65.2 |
| Example 6 | LiVOPO₄ | 12 | 2.3 | 8 | 4.8 | 1.15 | 73.2 |
| Example 7 | LiVOPO₄ | 12 | 2.3 | 8 | 4.8 | 1.3 | 77.8 |
| Example 8 | LiVOPO₄ | 12 | 2.3 | 8 | 4.8 | 1.65 | 79.9 |
| Example 9 | LiVOPO₄ | 5.5 | 1.8 | 8 | 4.1 | 1 | 60.6 |
| Example 10 | LiVOPO₄ | 19 | 1.8 | 8 | 4.9 | 1 | 61.7 |
| Example 11 | LiVOPO₄ | 12 | 1.8 | 8 | 10 | 1 | 50.2 |
| Example 12 | LiVOPO₄ | 12 | 1.8 | 8 | 1 | 1 | 51.2 |
| Example 13 | Li₃V₂(PO₄)₃ | 12 | 2.1 | 5.2 | 1.3 | 1 | 61.1 |
| Example 14 | LiVPO₄F | 12 | 2.3 | 5.5 | 1.1 | 1 | 60.2 |
| Example 15 | LiVOPO₄ | 12 | 2.55 | 16 | 4.8 | 1 | 60 |
| Example 16 | LiVOPO₄ | 12 | 1.8 | 8 | 4.8 | 1.75 | 60.6 |
| Example 17 | LiVOPO₄ | 4 | 1.8 | 8 | 4.7 | 1 | 55.7 |
| Example 18 | LiVOPO₄ | 9 | 1.8 | 8 | 4.7 | 1 | 65.7 |
| Example 19 | LiVOPO₄ | 15 | 1.8 | 8 | 4.7 | 1 | 67.8 |
| Example 20 | LiVOPO₄ | 22 | 2.75 | 8 | 4.6 | 1 | 57.5 |
| Example 21 | LiVOPO₄ | 12 | 1.8 | 17 | 4.8 | 1 | 58.5 |
| Example 22 | LiVOPO₄ | 12 | 1.8 | 3.8 | 4.8 | 1 | 50.4 |
| Example 23 | LiVOPO₄ | 12 | 1.8 | 5 | 4.8 | 1 | 55.8 |
| Example 24 | LiVOPO₄ | 12 | 1.8 | 20 | 4.8 | 1 | 53 |
| Example 25 | LiVOPO₄ | 12 | 1.8 | 25 | 6.5 | 1 | 51.2 |
| Example 26 | LiVOPO₄ | 12 | 2.9 | 4 | 5.9 | 1 | 50.1 |
| Example 27 | LiVOPO₄ | 12 | 1.8 | 8 | 4.8 | 0.9 | 45.9 |
| Example 28 | LiVOPO₄ | 12 | 1.8 | 8 | 4.8 | 2 | 49.3 |
| Example 29 | LiVOPO₄ | 12 | 2.3 | 8 | 4.8 | 1 | 74.2 |
| Example 30 | LiVOPO₄ | 12 | 2.3 | 8 | 4.8 | 1 | 75.6 |
| Example 31 | LiVOPO₄ | 12 | 2.3 | 8 | 4.8 | 1 | 77.3 |
| Example 32 | Li₃V₂(PO₄)₃ | 12 | 2.05 | 6.5 | 1.1 | 1 | 60.2 |
| Example 33 | Li₃V₂(PO₄)₃ | 12 | 2.2 | 4.8 | 1.6 | 1 | 63.5 |
| Example 34 | Li₃V₂(PO₄)₃ | 12 | 2.3 | 3.7 | 1.9 | 1 | 62.9 |
| Example 35 | Li₃V₂(PO₄)₃ | 12 | 2.5 | 3.1 | 2.4 | 1 | 61.6 |
| Comparative | LiVOPO₄ | 12 | 2.95 | 3.5 | 7.8 | 1 | 41.2 |
| Example 1 | | | | | | | |
| Comparative | LiVOPO₄ | 12 | 1.78 | 20 | 0.8 | 1 | 42.4 |
| Example 2 | | | | | | | |

### DESCRIPTION OF REFERENCE NUMERALS

10 Positive electrode
20 Negative electrode
12 Positive electrode current collector
14 Positive electrode active material layer
18 Separator
22 Negative electrode current collector
24 Negative electrode active material layer
30 Stacked body
50 Casing
60, 62 Lead
100 Lithium ion secondary battery

1. A lithium ion secondary battery comprising a positive electrode, a negative electrode, and an electrolyte solution, wherein
the positive electrode uses a compound expressed by an expression as a positive electrode active material; and
the positive electrode has an electrode density of 1.8 to 2.9 g/cm³,
the expression being Liₐ(M)_{b}(PO₄)_{c}X_{d} (where M is VO or V, X is F, and 0.9≦a≦3.3, 0.9≦b≦2.2, 0.9≦c≦3.3, 0≦d≦1.1).

2. The lithium ion secondary battery according to claim 1, wherein
the electrolyte solution includes a lithium salt; and
the lithium salt has a salt concentration of 1.1 to 1.7 mol/L.

3. The lithium ion secondary battery according to claim 1, herein the positive electrode has a BET specific surface area of 5 to 20 m²/g as an electrode.

4. The lithium ion secondary battery according to claim 1, wherein the positive electrode has a pore volume of 0.01 to 0.1 cm³/g.

5. The lithium ion secondary battery according to claim 1, wherein the positive electrode has a positive electrode active material loaded amount of 5 to 20 mg/cm².

6. The lithium ion secondary battery according to claim 1, wherein the compound is LiVOPO₄ or Li₃V₂(PO₄)₃.

7. The lithium ion secondary battery according to claim 1, wherein an aluminum-laminated film is used as an outer package.
